(19) United States
(12) Patent Application Publication
(10) Pub. No.: US 2023/0289460 A1
(43) Pub. Date: Sep. 14, 2023

(54) SENSITIVE DATAFLOW TRACKING SYSTEM AND METHOD

(71) Applicant: SRI International, Menlo Park, CA (US)

(72) Inventors: Ashish Gehani, Atherton, CA (US); Phillip A. Porras, Cupertino, CA (US); Vinod Yegneswaran, Foster City, CA (US); Hassaan Irshad, Union City, CA (US)

(21) Appl. No.: 18/016,402

(22) PCT Filed: Apr. 30, 2021
(86) PCT No.: PCT/US2021/030098

§ 371 Date: Jan. 16, 2023

Related U.S. Application Data
(60) Provisional application No. 63/053,988, filed on Jul. 20, 2020.

(51) Int. Cl. G06F 21/62; G06F 11/34

(52) U.S. Cl. CPC G06F 21/6218; G06F 11/3495

(57) ABSTRACT

Systems and methods for providing sensitive dataflow tracking for containerized applications is provided herein. In some embodiments, a taint tracking system for providing sensitive dataflow tracking may include an audit reporter configured to create a provenance graph; a taint tracking kernel configured to (1) create a screened provenance graph that includes data deemed sensitive, and (2) create one or more final taints set of sensitive data to be tracked at a container level that includes vertices and edges that are descended from a particular sensitive source using one or more dependency checkers; and a taint storage configured to store the taint sets of sensitive data to be tracked at the container level.

### FIELD

Embodiments of the present principles generally relate to container network applications and, and more particularly, to providing sensitive dataflow tracking system and methods for containerized applications.

### BACKGROUND

Containers are utilized widely to decompose complex production Internet services into manageable (componentized) microservices. The use of containerization technologies for virtual application deployment, particularly for the scalable instantiation of production microservices, has grown at an astonishing rate. Large-scale industrialized container applications are deployed as front-line services that handle highly sensitive information. However, today's security solutions perform policy monitoring or enforcement from the perspective of application actions or network security policy control, with little insight into how and where sensitive information is stored within the container environment or transmitted across pipelines of cooperating containerized applications. Today's container security solutions are ineffective, or at best coarse-grained, in their ability to enforce even basic data security compliance requirements for sensitive data at rest (i.e., when stored in files). Data provenance is a record of the history of data traversing or being used by a system or network of systems. Such history information can be used to assure correctness and security of data, and also to help understand and protect the system's operations and information. Market solutions today do not perform sensitive data provenance or taint tracking for containerized application, which would enable them to prevent certain network communications that could result in unauthorized exfiltration of this data. Solutions today do not provide fine-grained forensic tracking of sensitive information via file access tracking, through inter-process communication, or via network connections.

Currently, the ability to track provenance or taint tracking has been performed within the scope of the local host. However, in containerized environments, discrete applications are composed into a system or service. Further, these applications can be hosted across different container instances or even across different hardware assets. For example, current dataflow tracking systems such as SPADE (Support for Provenance Auditing in Distributed Environments) have largely focused on tracking activity at a per-system level. SPADE is a software infrastructure for data provenance collection and management developed by SRI International. The underlying data model used throughout the system is graph-based, consisting of vertices and directed edges. However, SPADE and other systems do not have the ability to effectively isolate activity happening within virtualized containers. Other systems or frameworks for application system call monitoring provide container-specific tags. These systems do not provide dataflow tracking capabilities. Furthermore, these systems provide no support for tracking sensitive dataflows across containers.

Thus, there is a need for a provenance-based live container monitoring system that can provide fine-grained forensic tracking of sensitive information via file access tracking, through inter-process communication, or via network connections.

### SUMMARY

Embodiments of Systems and methods for providing sensitive dataflow tracking for containerized applications are disclosed herein. In some embodiments, a taint tracking system for providing sensitive dataflow tracking for containerized applications may include an audit reporter configured to receive audit records including container information and to create a provenance graph of vertices and edges associated with kernel system call events being monitored based on the received audit records, a taint tracking kernel configured to (1) create a screened provenance graph that includes data deemed sensitive by performing a first level of pruning of the provenance graph using one or more storage screens, and (2) create one or more final taints set of sensitive data to be tracked at a container level that includes vertices and edges that are descended from a particular sensitive source using one or more dependency checkers; and a taint storage configured to store the taint sets of sensitive data to be tracked at the container level.

In some embodiments, a method for providing sensitive dataflow taint tracking for containerized applications may include generating one or more synthesized audit records based on received event audit records that includes container information associated with each event included in the synthesized audit records, creating a provenance graph of vertices and edges associated with kernel system call events being monitored based on the one or more synthesized audit records, creating a screened provenance graph that includes data deemed sensitive by performing a first level of pruning of the provenance graph using one or more storage screens, creating one or more final taints set of sensitive data to be tracked at a container level, that includes vertices and edges that are descended from a particular sensitive source using one or more dependency checkers, and storing the taint sets of sensitive data to be tracked at the container level within a taint storage.

In some embodiments, one or more non-transitory computer readable media may include instructions stored thereon which, when executed by one or more processors, cause the one or more processors to perform operations that include generating one or more synthesized audit records based on received event audit records that includes container information associated with each event included in the synthesized audit records, creating a provenance graph of vertices and edges associated with kernel system call events being monitored based on the one or more synthesized audit records, creating a screened provenance graph that includes data deemed sensitive by performing a first level of pruning of the provenance graph using one or more storage screens, creating one or more final taints set of sensitive data to be tracked at a container level, that includes vertices and edges that are descended from a particular sensitive source using one or more dependency checkers, and storing the taint sets of sensitive data to be tracked at the container level within a taint storage.

In some embodiments, a method for providing network-tagged provenance coordination for containerized applications may include receiving a network tagged specification file that includes a list of all vertices that are deemed sensitive and therefore should be tracked, initiating one or more network-tagged provenance coordination (NTPC) systems, checking, by the one or more NTPC systems, all outgoing network packets to determine whether any network packets meets criteria defined in a network tagged specification file, and including, by the one or more NTPC systems, a label to a header of any network packets that meets the criteria defined in a network tagged specification file.

In some embodiments, a method of providing sensitive dataflow policy violations may include deploying one or more networked taint tracking systems on a network, detecting, by the networked taint tracking systems, sensitive data requiring taint tracking based on analysis of received event audit records, generating, by the one or more networked taint tracking systems, taints sets that include sensitive data being monitored and result in the tracking of sensitive dataflow policy violation alerts, and storing the taint sets of sensitive data being monitored at the container level within a taint storage.

Other and further embodiments in accordance with the present principles are described below.

### BRIEF DESCRIPTION OF THE DRAWINGS

So that the manner in which the above recited features of the present principles can be understood in detail, a more particular description of the principles, briefly summarized above, may be had by reference to embodiments, some of which are illustrated in the appended drawings. It is to be noted, however, that the appended drawings illustrate only typical embodiments in accordance with the present principles and are therefore not to be considered limiting of its scope, for the principles may admit to other equally effective embodiments.

FIG. 1 depicts a high-level block diagram of a network architecture including a plurality containerized host computer systems implementing sensitive dataflow tracking systems in accordance with an embodiment of the present principles.

FIG. 2A depicts a high-level block diagram of the components and associated processes for creating a synthesized audit record that is input into the sensitive dataflow tracking systems in accordance with an embodiment of the present principles.

FIG. 2B depicts a high-level block diagram of a sensitive dataflow tracking system in accordance with an embodiment of the present principles.

FIG. 3 depicts information associated with the Open Provenance Model in accordance with the present principles.

FIG. 4 depicts a high-level block diagram of components and associated processes used by the dependency checker in accordance with the present principles.

FIG. 5 depicts a flow diagram of a method for sensitive dataflow tracking by creating a provenance graph including sensitive data in a containerized application environment, in accordance with an embodiment of the present principles.

FIG. 6 depicts a high-level block diagram of a computing device suitable for use with embodiments of a sensitive dataflow tracking system in accordance with the present principles.

FIG. 7 depicts a high-level block diagram of a network in which embodiments of a container security system in accordance with the present principles, such as the sensitive dataflow tracking of FIG. 2B, can be applied.

FIG. 8 depicts a flow diagram of method of providing sensitive dataflow policy violations, in accordance with an embodiment of the present principles.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present principles generally relate to methods, apparatuses and systems for provenance-based live container monitoring that can provide fine-grained forensic tracking of sensitive information via file access tracking, through inter-process communication, or via network connections. Although defined in terms of container monitoring of containerized application, embodiments of the present principles also apply to non-containerized regular applications as well. While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims. For example, although embodiments of the present principles will be described primarily with respect to specific container applications and container networks, such teachings should not be considered limiting. Embodiments in accordance with the present principles can function with substantially any container applications and container networks.

Embodiments of the provenance-based live container monitoring systems and methods described herein enable many of the capabilities not previously achievable thru any individual system. Embodiments of the disclosed sensitive dataflow tracking system will address the problem of real-time tracking of sensitive processes and objects that are instantiated within virtualized containers. It will enable dataflow tracking of all sensitive container activity by monitoring from a centralized vantage point, specifically system call streams from the host operating system. For example, some containerized internet services/applications need to access a variety of different sensitive business data, patient private data, financial data, personal private information. In general, sensitive data may be broadly defined as any data that any party would want to monitor and protect and be able to track access, usage, storage and movement of said data. That type of sensitive data, and/or information associated with that sensitive data (file names, data locations, IP addresses, etc.), can be tracked in a containerized environment by embodiments consistent with the present disclosure.

When certain types of sensitive data is processed in computing environments, there may be stringent compliance requirements that specify what minimum security features need to be associated with interaction, storage and tracking of such sensitive data. Most of those compliance requirements require or request some type of tracking and protection to encrypt and control access to that sensitive data. Embodiments consistent with the present disclosure advantageously accomplish this by doing application level process monitoring in a containerized environment using much more performance efficient techniques like eBPF (extended Berkley Packet Filter) or kernel extensions that augment the kernel with hooks to capture data and to do so more efficiently than what could be achieved using typical audit streams in the host.

The inventive systems and methods described herein for sensitive dataflow tracking for containerized application, also referred to as live data governance, will offer the first approach to sensitive data-flow tracking that will scale to large, containerized ecosystems of applications. The inventive systems and methods deliver new data flow tracking policy capabilities within a container by enabling a facility to track all sensitive data objects and tainted applications within the container. Finally, the inventive systems and methods offer an entirely novel approach to tracking this sensitive data as it flows across pipelines of cooperating containers and to backend services. This is realized through a concept called provenance coordination that utilizes network packet flow tags.

The aforementioned embodiments and features are now described below in detail with respect to the Figures.

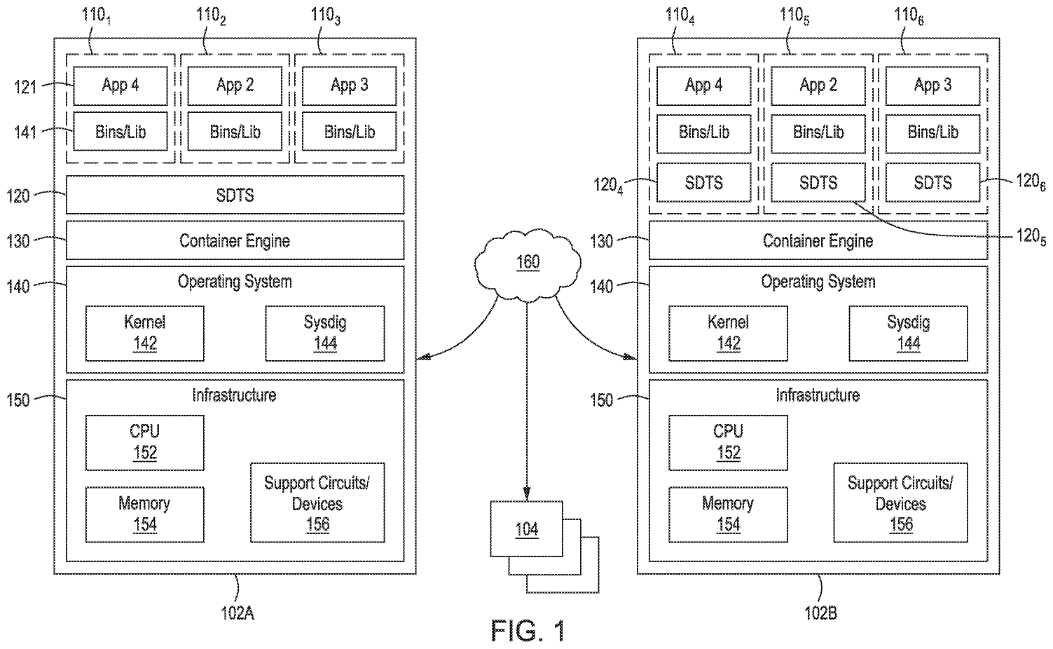

FIG. 1 depicts a high-level block diagram of a network architecture 100 including a plurality containerized host computer systems 102A, 102E implementing sensitive dataflow tracking systems and other computer systems/device 104 communicatively coupled over one more networks 160. Each of the containerized host computer systems 102A, 102E includes a plurality of containers 1101-x and may communicate with each other, and/or with other systems/devices 104, over network 160. Each of the virtual containers created on the host computer systems 102A, 102E includes one or more containerized applications 112 and Bins/Libs 114 associated with the one or more containerized application 112. The Bins/Libs 114 include the binaries and system libraries and settings needed to run the applications 112. In some embodiments, the plurality of networked containerized host computer systems 102A, 102E implementing sensitive dataflow tracking systems shown in FIG. 1 may be deployed and implemented on an enterprise network to provide enterprise taint tracking.

The container engine 130 includes the containerization technology to communicate with the operating system 140/kernel 142 to build and containerize the applications 112 and create containers 110. There are several existing commercial container engines that may be used with embodiments of the present disclosure including DOCKER, CRI-O, RAILCAR, RKT, LXC, etc. In some embodiments, custom container engines may be built and/or used.

The operating system (OS) 140 and its kernel 142 generally manages various computer resources and host computer system infrastructure 150. Examples of the operating system 140 may include, but are not limited to, various versions of LINUX and the like. In some embodiments, the kernel 142 is domain agnostic. The host computer system infrastructure 150 may include one or more CPUs 152, memory/storage devices 154, and support circuits/devices 156. The CPU 152 may include one or more commercially available microprocessors or microcontrollers that facilitate data processing and storage. The various support circuits 156 facilitate the operation of the CPU 152 and include one or more clock circuits, power supplies, cache, input/output circuits, and the like. The memory 154 includes at least one of Read Only Memory (ROM), Random Access Memory (RAM), disk drive storage, optical storage, removable storage and/or the like.

Each of the containerized host computer systems 102A, 102E includes one or more Sensitive Data Tracking Systems (SDTS) 120 configured to provide fine-grained forensic tracking of sensitive information via file access tracking, through inter-process communication, or via network connections. In at least some embodiments consistent with the disclosed models herein, each container 100 can be managed by an independent SDTS 120, which follows a container-specific sensitive dataflow tracking architecture. In some embodiments, as shown in containerized host computer systems 102A, a single SDTS 120 is implemented and handles all sensitive data tracking across all containers 1101-3 and containerized applications 1121-3. In other embodiments, containerized host computer systems 102B, separate instances of the SDTS 1204-6 are associated with each container 1104-6 and containerized applications 1124-6.

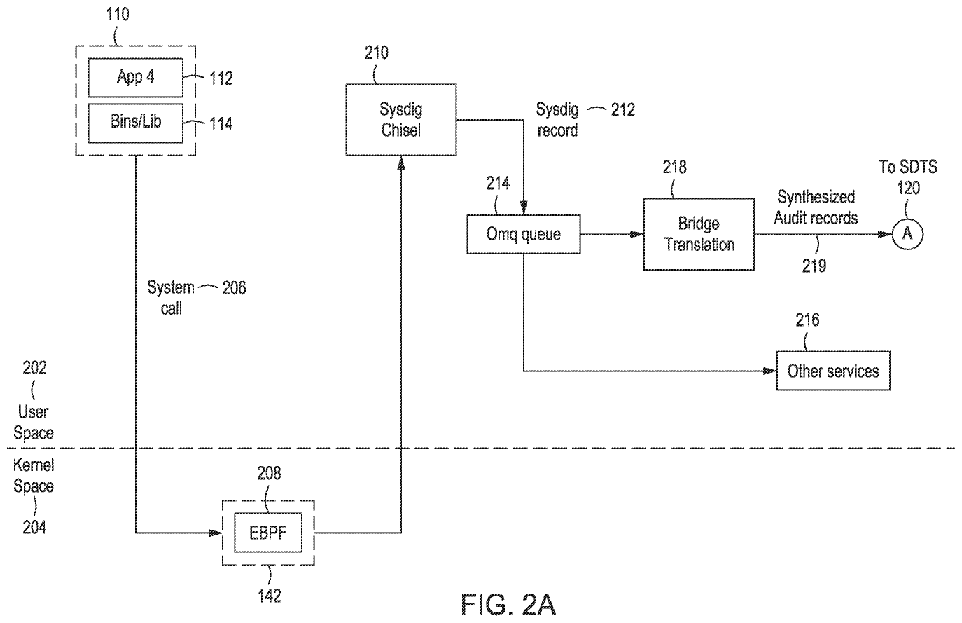

The SDTS 120 performs application level process monitoring in a containerized environment using performance efficient techniques like eBPF (extended Berkley Packet Filter) or kernel extensions that sit in the kernel space and augment the kernel 142 with hooks to capture data and to do so more efficiently, and the use of SYSDIG/SYSDIG Chisel 144 which sits in the space. These components and associated processes are described in further detail with respect to FIGS. 2A and 2B.

FIG. 2A depicts the components and associated processes for creating a synthesized audit record that is input into the SDTS 120 which is shown in FIG. 2B. As shown in FIG. 2A, a containerized application 112 within container 110 makes systems calls 206 to the kernel 142 to perform certain functions or activate/use certain host system infrastructure 150. The eBPF toolkit/mechanism 208 is part of the kernel and is a mechanism that extends the kernel 142 to capture information associated with those system calls 206. For example, when a system call 206 from containerized application 112 is made, the kernel 142 accepts the open system call 206 (called the entry point), and then the kernel 142 processes the system call 206 and returns the result of the open call (called the exit point). The eBPF mechanism 208 provides a way of adding programming logic to the entry point and exit point of the kernel 142 to be able to capture desired information regarding the system calls 206 made. Meanwhile, the SYSDIG toolkit/mechanism 144 provides a higher abstraction level that makes it easier to specify what information to capture and the format of the data structure containing that information captured. For example, when an open system call 206 is made that has associated arguments with the call, the SYSDIG mechanism 144 allows a user to ask the eBPF mechanism 208: “Could you please give me a data structure that captures the various arguments of the open call when you enter it?” Thus, with the SYSDIG mechanism 144, one can configure and make requests to receive data structures that can be processed in a higher level programming logic. Furthermore, the SYSDIG chisel mechanism 210 provides a further level abstraction above SYSDIG that allows a higher level configuration of SYSDIG such as the ability to identify which system calls to be on the lookout for and their associated conditions, as well as what attributes are desired to be reported out. As described herein, the SYSDIG Chisel mechanism 210 is part of the SYSDIG mechanism 144 shown in FIG. 1. In some embodiments, SYSDIG chisels are minimal Lua scripts for examining the SYSDIG event stream to carry out useful system troubleshooting and/or monitoring/auditing actions. As described above, the SYSDIG 144, and SYSDIG Chisel 210 mechanisms, along with the eBPF 142 mechanism, and provide a flexible and convenient way to, at a configuration level, request a certain number of system calls and get data from them, and then specify whether the data should be recorded/audited when the system call 206 enters the kernel or when the system call 206 exits the kernel. In some embodiments, the SYSDIG chisel 210 mechanism is programmed to monitor and record about 70-90 types of system calls (of about 360+ total kernel system calls) for sensitive data flow tracking purposes.

As the SYSDIG chisel 210 mechanism receives the requested information from the eBPF 142 mechanism, it builds a data event stream of the system calls requested and sends the SYSDIG record 212 to the 0mq queue 214. The SYSDIG record 212 is a data structure that includes a collection of key/value pairs that associated with the system calls being monitored. The 0mq queue 214 is an asynchronous messaging library, aimed at use in distributed or concurrent applications, that provides a message queue for the SYSDIG record 212 and is a well-known type of queue to those skilled in the art. The SYSDIG record 212 is then sent to the SDTS 120 and/or other services 216 to be processed. In some embodiments, the other services 216 may include a Variational Autoencoder (VAE) record consumer or the like.

Next, the SYSDIG event stream in the form of the SYSDIG record 212 and translating that using a Bridge Translator 218 into a synthesized audit record format 219. The Bridge Translator 218 shown in the SDTS 120 introduces container information into the synthesized audit record format 219 which was originally obtained from the SYSDIG record 212. The container information introduced may include container identifiers and names. Specifically, since containers are a user space notion, and not a kernel space notion, the kernel 142 does not provide container information. That is, the audit records that come out of the kernel 142 normal audit event stream has no mention of containers because containers are not a kernel construct, but rather a user space construct. However, the SYSDIG mechanism 144 actually does some housekeeping to actually keep track of this and it is therefore able to keep track of this container information associated with the system calls and records it's generating, including information related to which containers the records are associated with it by including container labeling with the system call information. The bridge translator 218 than synthesizes that additional container information into a synthesized audit record format 219 for input into the taint tracking system 220, and more specifically to the audit reporter 222 within the taint tracking system 220.

The Bridge Translator 218 includes translation algorithms which translates the SYSDIG record 212 format for reporting a system calls and puts this information in a different syntactic form from the syntactic form. The typical role of this translation is the syntactic mapping from SISDIG record format. However, as described above, in embodiments consistent with the present invention, the SDTS bridge translator 218 includes the container information to create a synthesized audit record format 219 for input into the taint tracking system 220, and more specifically to the audit reporter 222 within the taint tracking system 220.

As noted above, current dataflow tracking systems such as SPADE have largely focused on tracking activity at a per-system level. However, SPADE and other systems do not have the ability to effectively isolate and track activity happening within virtualized containers. Furthermore, original SPADE systems included multiple front end modules for pulling provenance data from different domains, multiple audit reporters, multiple different backend modules which are called storages for storing data in different formats, and a full kernel which was larger and more difficult to maintain. In the SDTS 120, rather than use SPADE, embodiments consistent with the present sensitive data tracking system use the inventive taint tracking audit system 220. The taint tracking system 220 includes a single audit reporter 222, a single taint tracking kernel 226, and a single taint storage 228. The taint tracking system 220 is advantageously more efficient and a lighter weight solution. Furthermore, the taint tracking system 220 is specifically designed to operate in a containerized environment which SPADE and other tracking systems are not.

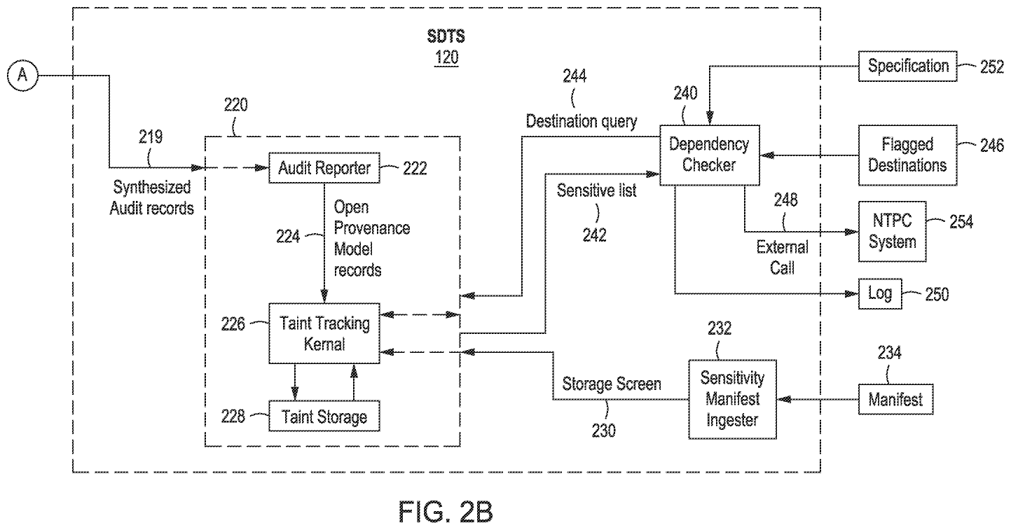

When in the single audit reporter 222 receives the synthesized audit record 219, it is able to interpret the container labels/information included in them, as opposed to previous, or opensource versions of SPADE audit reporters and the like which do not have that functionality. Specifically, the audit reporter 222 processes the synthesized audit record 219 from SYSDIG/SYSIG chisel 144, 210 and creates a provenance graph of vertices and edges in an Open Providence Model (OPM) record format. The Open Provenance Model record 224 (also referred to herein as a provenance graph 224) is an accepted standard model record of provenance that is designed to meet the following requirements: (1) Allow provenance information to be exchanged between systems, by use of a compatibility layer based on a shared provenance model. (2) Allow developers to build and share tools that operate on such a provenance model. (3) Define provenance in a precise, technology-agnostic manner. (4) Support a digital representation of provenance for things, whether produced by computer systems or not. (5) Allow multiple levels of description to coexist. (6) Define a core set of rules that identify the valid inferences that can be made on provenance representation. The Open Provenance Model record 224 aims to capture the causal dependencies between the artifacts, processes, and agents. Therefore, a provenance graph is defined as a directed graph, whose nodes are artifacts, processes and agents, and whose edges belong to one of the following categories depicted in FIG. 3. A provenance graph is a directed graph G=(V_{G}, E_{G}), with vertex set V_{G} and edge set E_{G}. Vertices in V_{G} represent the provenance graph elements (i.e. entities, activities, and agents). There is an edge e=(vᵢ,vⱼ)∈E_{G} if there is a provenance relation in the graph relating vertex vᵢ to vⱼ, vᵢ,vⱼ∈V_{G}, in that direction. That is, an edge represents a causal dependency, between its source, denoting the effect, and its destination, denoting the cause. Thus, the audit reporter 222 produces one or more OPM records 224, which is a provenance graph as described above, and provides it to the taint tracking kernel 226. In some embodiments, the provenance graph is a property graph that includes annotations on the vertices and edges which have key-value pairs associated with them. It is those annotations where all the domain semantics of interest get captured.

In some embodiments, the taint tracking kernel 226 is designed to only have one front end and one back end and no points of extensibility (also referred to as a unikernel). The one front end of the taint tracking kernel 226 receives the OPM records 224 from the audit reporter 222, and the one back end is used for the taint storage 228. Thus, it is very streamlined as opposed to the kernels used in SPADE systems or other tracking systems. For example, as discussed above, a kernel of a typical SPADE implementation allows multiple reporters, which are each sending provenance graph streams, which is basically streams of elements of vertices and edges. It also allows extensions and filters and requires much more storage requirements. Meanwhile, the taint tracking kernel 226 removes the ability to add filters and extend the kernel functionality. It takes away the ability to add multiple streams of provenance data from multiple different audit reporters. In some embodiments, the taint tracking kernel 226 is configured to use one audit reporter 222 at a time, and it's only designed to have one taint storage 228.

The taint storage 228 stores the provenance graph sent by the taint tracking kernel 226. The taint tracking kernel 226 uses one or more tools to prune/filter the provenance graph (i.e., OPM records 224) stored in the taint storage 228. In some embodiments, the taint tracking kernel 226 uses a storage screen to screen/filter vertices and/or edges that get stored in the provenance graph. In addition, one or more dependency checkers 240 are used to further prune/filter the provenance graph stored in the taint storage 228. In some embodiments, the dependency checker 240 extends the functionality of the taint storage 228 and is a subclass of the taint storage 228. These tools and features are described below in further detail.

When the taint tracking kernel 226 receives the provenance graph 224 from the audit reporter 222, the vertices and edges in the provenance graph passed through one or more storage screens 230 as configured. For every vertex and edge that comes into the taint tracking kernel 226, the storage screens 230 checks them against criteria it has been configured with to decide whether to pass that vertex or edge through to the taint storage. Thus, the storage screen 230 screens/cleans out elements that are coming into the taint storage to decide whether they should be stored or not. A sensitivity manifest 234 is used to configure the storage screen 230, or in other words, the sensitivity manifest 234 can implemented as a storage screen. The sensitivity manifest 234 is provided to the Sensitivity Manifest Ingester 232 to create the one or more storage screens 230 launched and used by the taint tracking kernel 226 to screen which vertices and edges are to be stored. An end user is able to define in the sensitivity manifest 234 which annotated provenance vertices and/or edges should be considered sensitive. That is, the user can specify particular files, particular processes, particular network flows, locations, names, information and the like that may be deemed sensitive, such that access or sending/receiving of such is considered a policy violation that should be tracked, stored and reported as a policy violation alert. Therefore in some embodiments, the taint tracking systems 220 may generate taints sets including sensitive dataflow tracking policy violation alerts through the a-priori tracking of sensitive data used in containerized applications by tracking information listed in the sensitivity manifest.

Thus, one aspect of sensitive dataflow tracking is defining an initial sensitivity manifest 234 (or configuration) that describes to the taint tracking system 220 of the SDTS 120 where sensitive data is located within the container 110, which application 112 may produce new sensitive data, and from which vectors (e.g., remote network service) sensitive data may be imported. In some embodiments, the SDTS 120 includes thus use of one or more per-container sensitive data manifests 234, which captures information to ascertain where sensitive data is located, produced, or imported at instantiation and runtime of the container. The sensitive data manifest 234 is a dynamic document that is updated to reflect the current state of the above information across reinitializations of the container. In some embodiments, the sensitivity manifest 234 is a subclass of the storage screen (e.g., a Java subclass of the storage screen Java class). When an instance of the sensitive data manifest 234 is run, it inputs a JSON configuration describing sensitive sources. The taint tracking kernel 226 loads the sensitivity manifest 234, which reads the JSON during initialization. When graph elements enter the taint tracking kernel 226 from the audit reporter 222, they are screened by the sensitivity manifest 234. If they pass through, they go to the Dependency Checker 240, which in some embodiments is a subclass of the taint storage 228).

There are three major elements involved in the definition of the sensitive data source manifest: (1) where, within the data stores accessible to the instantiated container, sensitive information is located. This will include file-system objects and data service found within the container or within the filesystem (hosted) mount points of the container; (2) Which applications are designated as producers or accessors of sensitive data. This involves, for each application instantiated within the container, indications as to whether the application is intended, as part of its function to produce, store, or access sensitive data; and (3) From which external locations sensitive data can be imported. This involves the enumeration of network addresses or domain names, as well as port-specific refinements if sensitive data is served via specific network TCP or UDP ports, or data channels that are available to container applications from the host on which the container runs (e.g., a named pipe or Unix domain socket).

In some embodiments, the sensitive data manifest is a static document. If the sensitive data manifest is changed, the taint tracking system may need to be restarted. In other embodiments, the sensitive data manifest is a dynamic document that is updated to reflect the current state of the above information across reinitializations of the container. The sensitive data manifest may include a disjunction of conjunctions of one or more key-value pairs of data, which are descriptions of resources, such as filesystem paths, program names, network addresses, etc.

Since storage screen 230 based on the sensitivity manifest 234 is used by the taint tracking kernel 226, only vertices which are deemed sensitive along with and all edges are permitted to pass through to the taint storage 228, and vertices which are not sensitive are not allowed through. Thus, the taint storage 228 has a screened list of sensitive sources since every vertex has been checked against the storage screen 230/sensitivity manifest 234 and the criteria defined therein. More specifically, all edges pass through the sensitivity manifest screen 230 since it is not known at the point of screening whether an edge may be connected to a descendant of a sensitive source. In the taint storage 228, a check is performed to determine whether the parent endpoint vertex of the edge is in any of the taint sets. In each case that it is, the child endpoint vertex is added to the corresponding taint set, thereby propagating taint.

The next level of filtering/pruning of the provenance graph is performed by the dependency checker 240, which, as described above, is an extension of the taint storage 228. In prior work on provenance, checking whether a datum contains sensitive information (to decide whether it can be sent to the public network, for example) has been affected by collecting the graph elements, and performing an ancestral lineage query from the vertex corresponding to the datum. If any element in the computed subgraph is known to be sensitive (based on a predefined list of such sources), the datum is deemed to contain sensitive information. However, this approach requires maintaining the entire provenance graph, which grows in proportion (or faster) to the time the system has been running.

In the disclosed approach, a set of sensitive vertices is maintained via the storage screen 230/sensitivity manifest 234 as described above. This set or list of sensitive vertices can be sent to the dependency checker 240 to be further seeded statically with vertices that correspond to extant resources in the target system, or dynamically by inspecting each vertex in each edge that is constructed at runtime, and checking if its relevant properties match those specified in a predefined list, in which case it is added to the seed set of sensitive vertices. Each time a graph edge is reported, the system checks if the parent vertex is present in the set of sensitive vertices. If it is, the child is added to the set of sensitive vertices. This approach allows the state maintained to be reduced to the set of vertices that contain a seed sensitive vertex in their provenance. This can be a significantly smaller amount of state than the full graph.

In a refinement, the state maintained can be implemented with a probabilistic data structure, such as a Bloom filter. By selecting graph vertex and edge properties so that distinct elements have different descriptions, content-based hashing can be used to generate vertex identifiers. When an element is to be added to the set of sensitive vertices, its identifier is inserted into the probabilistic data structure. In this variant, the state maintained is reduced to a constant at the cost of some false positives when set membership checks are subsequently performed.

More specifically, for every vertex that is passed through the storage screen 230 and is therefore deemed sensitive, the dependency checker 240 is used to keep track of the sub-graph that is descended from every sensitive vertex that comes in. The dependency checker 240 creates an associated data pair which includes the vertex and an associated taint set. This associated data pair is the set of vertices that are descendants in the provenance graph of this sensitive source.

Meanwhile, for every edge that is included in the screened provenance graph, since the edges are directed edges that have a parent and a child, a check is done by the dependency checker 240 to determine whether the parent is in any of the taint sets of sensitive data that are currently being maintained in the taint storage 228 (e.g., within the screened provenance graph stored in the taint storage 228). To be clear, as used herein, taint sets refer to the screened provenance graph stored in the taint storage after the storage screen filtering. Given a sensitive vertex (SV), the associated taint set is the set of vertices in the subgraph “rooted” at SV—i.e. all vertices for which SV is an ancestor via some provenance path. If the parent is in any of those taint sets, then the child is entered into the taint set as well. That is how taint is propagated from sensitive sources to its descendants. Thus, the dependency checker 240 prunes the provenance graph since it does not keep all the edges. It just keeps the set of vertices that are descended from a particular sensitive source, which reduces the amount of storage space required.

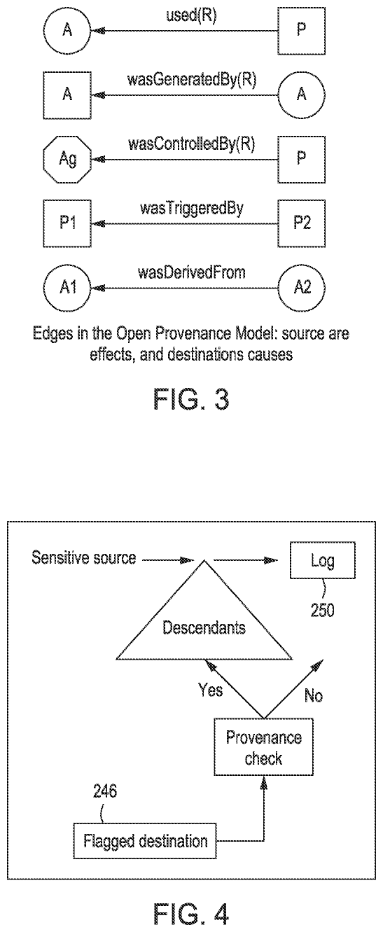

Furthermore, the dependencies checker 240 also does a check on every child of a received edge as shown in FIG. 4. Upon startup, the dependencies checker 240 loads a list of flagged destinations included in a flagged destination file 246. The list of flagged destinations is a configuration file which includes a list of vertices should be considered destinations that should be flagged as sensitive. In some embodiments, the format of the flagged destination file 246 is similar to that of the sensitivity manifest. A vertex that is considered a flagged destination is one that has a sensitive source in its ancestry (e.g., either a parent or a grandparent, etc., that was a sensitive source).

When the dependency checker 240 is initiated by the SDTS 120, it loads information from the flagged destination file 246 into memory. Thus, every time an edge is being processed by the dependency checker 240 which is an extension of the taint storage 228, a check is being done to see if the child of edge being processed is in the flagged destinations. If the child is in the flagged destinations, then a check is done to see if the parent is in any of the taint sets. If the parent is in any of the taint sets, that means there is a provenance path from a sensitive source to this flagged destination, and a log entry is generated in, or otherwise outputted to, a log 250 that indicates that there was a sensitive source that was associated with the flagged destination. As described above with respect to the sensitivity manifest, access or sending/receiving information from flagged destination may be considered a policy violation that should be tracked, stored and reported as a policy violation alert. Therefore in some embodiments, the taint tracking systems 220 may generate taints sets including sensitive dataflow tracking policy violation alerts through the a-priori tracking of sensitive data used in containerized applications by tracking information listed in the flagged destination file.

As described above with respect to the taint tracking system 220 and use of the storage screen using the sensitivity manifest configuration files, and the dependency checker using the flagged destination configuration files, a user can specify particular files, particular processes, particular network flows, locations, names, information and the like that may be deemed sensitive, such that access or sending/receiving of such is considered a policy violation that should be tracked, stored and reported as a policy violation alert. Therefore, in some embodiments, the taint tracking systems 220 may generate taints sets including sensitive data being monitored and result in the tracking of sensitive dataflow policy violation alerts. More specifically, at a start point, and sets of annotations are provided in the form of the sensitivity manifest to determine if any of those annotations are on a provenance vertex of the provenance graph when it comes in (i.e., whether it matches). If there is a match, then the vertex should be considered the seed (i.e., starting point of a taint set). The sensitive data manifest may include a disjunction of conjunctions of one or more annotations or key-value pairs of data (e.g., one taint set on medical data, another one on financial processes on that) which define a set of rules that have to be met in order to consider it “sensitive.” This is the start point of data being deemed sensitive. Then, as end point, the flagged destinations are check via the dependency checker as described above. Within the inventive taint tracking system 220, given specification of start points and end points, the taint tracking system 220 determines if there is anything connected from a start point to an end point. If so, the taint tracking system 220 raises a policy violation alert, where a policy is defined as the avoidance of sending/receiving sensitive data listed in a sensitivity manifest to/from a flagged destination.

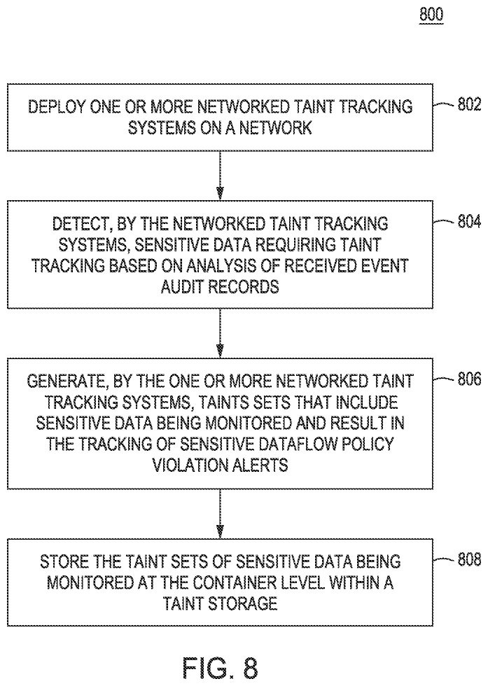

FIG. 8 depicts a method of providing sensitive dataflow policy violations in accordance with one or more embodiments of the present disclosure. In some embodiments, at 802, the taint tracking system 220 may deploy one or more networked taint tracking systems on a network. At 804, the system may detect sensitive data requiring taint tracking based on analysis of received event audit records. At 806, the system may generate taints sets that include sensitive data being monitored and result in the tracking of sensitive dataflow policy violation alerts. Finally, at 808, the system may store the taint sets of sensitive data being monitored at the container level within a taint storage.

In at least some embodiments, the SDTS 120 on which data flow analyses is conducted may itself be implemented across discrete containers that are physically distributed among multiple physical hosts (e.g., 102A and 102B). Therefore, in embodiments consistent with the present disclosure, network-tagged provenance coordination can be used across discrete containers that are physically distributed among multiple physical hosts. In this approach, the focus is on sensitive data that is transmitted from a process in Container A (e.g., container 1101) to another process in Container B (e.g., container 1104) on different hosts (e.g., 102A and 102B). Across physical hosts, the dominant method for implementing these data flow exchanges are through network connection such as TCP/IP connections. The concept of flow tags (that has been used for delivering meta data across network middlebox components) can be used for this purpose. The SDTS 120 used by in container A will maintain a dynamic list of processes that have created or accessed sensitive data: this can be labeled as a sensitive-tainted process. The system can implement a mechanism in container A's network stack that will receive an indicator from A's SDTS 120 when a sensitive-tainted process accepts or initiates a connection to an external address. If this external address corresponds to the same organization that has instantiated container A, a flow-tag will be added by A's network service to indicate that the process involved in this connection is tainted with sensitive data. Different flow-tags can be used to indicate different categories of sensitive data.

In some embodiments, a network tagged specification 252 is provided, or otherwise loaded into, the SDTS 120. In some embodiments, the network tagged specification 252 may be the same format as the sensitivity manifest 234 and/or flagged destination file 246 described above. In some embodiments, the network tagged specification 252 will include a list of all the vertices that are deemed sensitive, and therefore should be tracked. The network tagged specification 252 may include a label associated with a description that include a specification of sensitive sources (i.e., vertices). If any vertex checked against this file matched the description in the network tagged specification 252, that label should be put on any network flow which is going out. Thus, for each label, if there is a flagged destination with a sensitive source in its provenance, and that flagged destination matches this label specification, then that label is associated with the packets that are going out.

For example, for a given network flow from Container A on host 102A to Container B on hose 102B, if there is a vertex in container A's provenance which matches the description for label A, then label A is assigned, or otherwise associated with, the network packets being transmitted. In another example, there may be a process P which is connecting to a particular IP and pot. If process P had an ancestor in its provenance graph which indicated it was a sensitive source S, and sensitive source S has been put in the description associated with label A, then when network packets are transmitted from this process, label A is assigned, or otherwise associated with, the packets that are being transmitted.

Also, a sensitive source in the provenance of a flagged destination may match more than one label specifications. In this case, all the labels are added. In the flow tag implementation, an 8 bit field is used supporting up to 8 distinct labels. If a sensitive vertex matches the specifications for both labels i and j, the ith and jth bits are both set. Similarly, if two different sensitive sources in the provenance of a flagged destination match the ith and jth labels, respectively, both bits will be set on outbound packets. Thus, all the labels from all the sensitive sources (in the provenance of the flagged destination) are set.

In some embodiments, the network-tagged provenance coordination is performed by the dependency checker 240. In some embodiments, when the dependency checker 240 starts up, it loads the network tagged specification 252 into memory, and also makes an external call 248 to a network-tagged provenance coordination (NTPC) system/program 254. The NTPC program 254 launches, and while running, it can directed to include labels to any network packets that meets the criteria defined in the network tagged specification 252 (e.g., label any packets that are going out from a particular PID). It does this by using the eBPF toolkit/mechanism 208, and kicks off one or more processes that attaches to the kernel 142 where the function call which are involved in sending network packets out, as well as receiving packets. Whenever the dependency checker 240 wants to add another label for a particular processes or network flows, another external call 248 to initiate another NTPC program 254 process. This request is then transmitted down into the kernel space to the PID port that is attached to the function, which is at the end of the network stack processing of package internally, just before they get sent out to the network. The label is included in in IPv4 ToS (types of service) header field, which is an eight bit field that can hold up to eight labels. When a flagged destination has sensitive sources in its provenance, the aggregated set of labels that the sources match is computed, called a labelMask. The Dependency Checker can invoke a function in the NTPC that takes two arguments—the PID and the labelMask to be associated with outbound packets from the process with identifier PID. The goal is to set the TOS field of outbound packets to the labelMask. In some embodiments, two different Berkeley Packet Filter (BPF) programs are used. One receives the (PID, labelMask) from userspace. For packets sent by PID, it creates an association with the labelMask. A separate BPF program is attached to a different function in the Linux kernel that can modify the TOS field on packet egress. The second program checks for each packet if there is an associated labelMask. If one is present, it modifies the TOS field accordingly.

The aforementioned description described the network-tagged provenance coordination processes on the sending host system. In some embodiments, on the receiving host system, when a packet comes in, and it has some bits set indicated a taint/sensitivity label has been associated with the packet from the sending host system, additional processing is required. Specifically, when a packet comes in with one or more of the 8-bit ToS header bits set, what that translates to is the network artifact, i.e., the vertex representing the network flow, gets assigned an extra key-value/extra annotation. Thus, on the receiving host, the SDTS 120 may treat any network artifact which has these tags as another annotation, and treat that as a sensitive source. That is, on the receiving host, the network artifact will have an extra key-value annotation added to indicate that a flow tag was present. The updated vertex is becomes the seed vertex of a new taint set. Thereafter, the process receiving data from the network flow in question will be added to the taint set, along with its subsequent descendants as they arise.

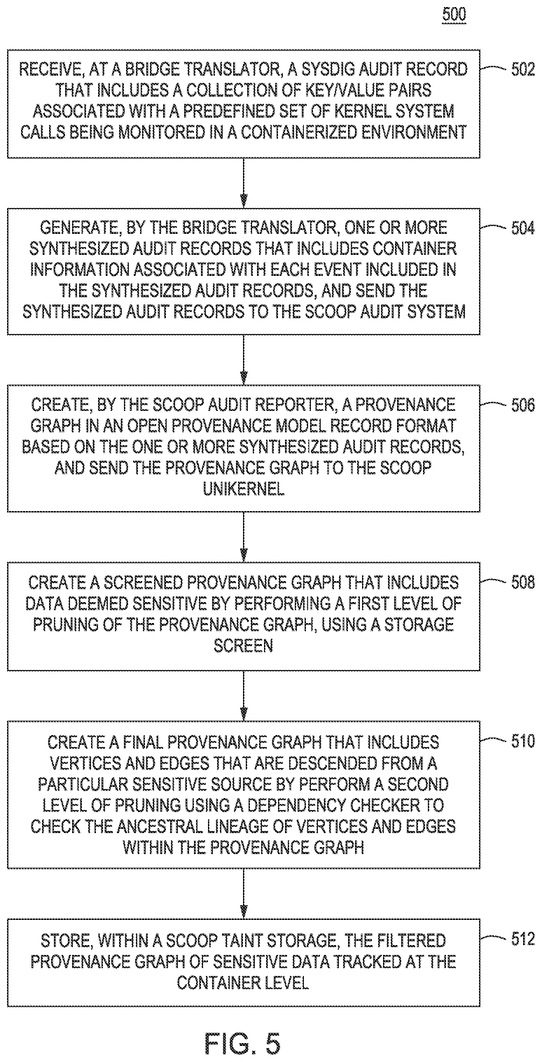

FIG. 5 depicts a flow diagram of a method 500 for sensitive dataflow tracking by creating a provenance graph including sensitive data in a containerized application environment. The method 500 begins at 502 where the SDTS 120 receives, at the bridge translator 218, a SYSDIG audit record that includes a collection of key/value pairs of a predefined set of kernel system calls 206 being monitored in a containerized environment. As described above with respect to FIG. 2A, the SYSDIG 144 and SYSDIG Chisel 210 mechanisms, along with the eBPF 208 mechanism, provides a flexible and convenient way to, at a configuration level, request a certain number of system calls and get data from them, and then specify whether the data should be recorded/audited when the system call 206 enters the kernel or when the system call 206 exits the kernel. In some embodiments, the SYSDIG chisel 210 mechanism is programmed to monitor and record a predefined set of about 70-90 types of system calls (of about 360+ total kernel system calls) for sensitive data flow tracking purposes within the containerized application environment. The bridge translator 218 receives the SYSDIG event audit record from the 0mq queue 214 messaging queue/library.

The method 500 proceeds to 504, where the bridge translator 218 generates one or more synthesized audit records 219 based on received event audit records that includes container information, including container identifier and name, associated with each event included in the synthesized audit records 219. Once generated, bridge translator 218 sends the synthesized audit records 219 to the taint tracking system 220. In some embodiments, the taint tracking system 220 includes a single audit reporter 222, a single taint tracking kernel 226, and a single taint storage 228.

At 506, a provenance graph 224 (also referred to as Open Provenance Model Records) is created by the audit reporter 222 in an open provenance model record format based on the one or more synthesized audit records 219. The provenance graph is a directed property graph that includes annotations on the vertices and edges that have key-value pairs associated with them. The audit reporter 222 then sends the provenance graph 224 to the taint tracking kernel 226 for further processing.

At 508, a screened provenance graph is created that includes data deemed sensitive by performing a first level of pruning of the provenance graph using a storage screen 230. As described above with respect to FIG. 2B, the taint tracking kernel 226 uses a storage screen 230 to screen/filter vertices and/or edges that get stored in the provenance graph. The sensitivity manifest 234 is provided to the Sensitivity Manifest Ingester 232 to create the one or more storage screens 230 used by the kernel to screen which vertices and edges are to be stored. An end user is able to define in the sensitivity manifest 234 which annotated provenance vertices and/or edges should be considered sensitive.

Once the screened provenance graph is created, a second level of filtering/pruning/screening is performed at 510 where a final provenance graph (i.e., the final taint set of sensitive data to be tracked at the container level) is created which includes vertices and edges that are descended from a particular sensitive source. This second level of filtering/pruning/screening is performed using the dependency checker 240 to check the ancestral lineage of vertices and edges within the provenance graph as described above with respect to FIG. 2A and FIG. 4.

At 512, the final taint set of sensitive data to be tracked at the container level (i.e., the filtered provenance graph of sensitive data tracked at the container level) is stored in the taint storage 228, where the method 500 ends.

FIG. 8 depicts a flow diagram of a method 800 of providing sensitive dataflow policy violations.

Embodiments of a sensitive data tracking system 120 and associated components, devices, and processes described can be implemented in a computing device 600 in accordance with the present principles. That is, in some embodiments, network packets, communications, data and the like can be communicated to and among containers and components of one or more host systems 102A, 102B including the sensitive data tracking system 120, using the computing device 600 via, for example, any input/output means associated with the computing device 600. Data associated with a sensitive data tracking system in accordance with the present principles can be presented to a user using an output device of the computing device 600, such as a display, a printer or any other form of output device.

For example, FIGS. 1, 2A and 2B depict high-level block diagrams of computing devices 102A and 102B suitable for use with embodiments of a sensitive data tracking system in accordance with the present principles. In some embodiments, the computing device 600 can be configured to implement methods of the present principles as processor-executable executable program instructions 622 (e.g., program instructions executable by processor(s) 610) in various embodiments.

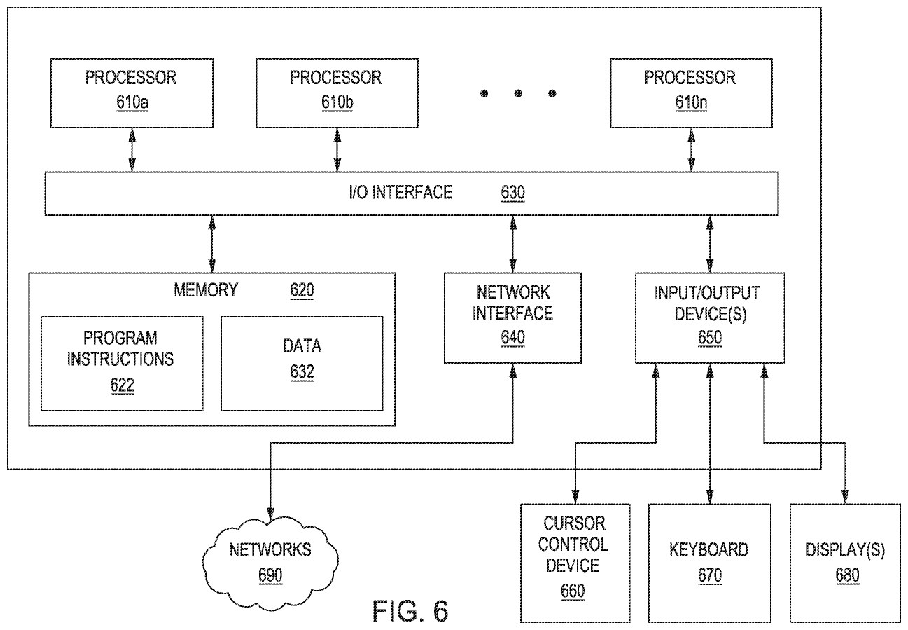

In embodiments consistent with FIG. 6, the computing device 600 includes one or more processors 610a-610n coupled to a system memory 620 via an input/output (I/O) interface 630. The computing device 600 further includes a network interface 640 coupled to I/O interface 630, and one or more input/output devices 650, such as cursor control device 660, keyboard 670, and display(s) 680. In various embodiments, a user interface can be generated and displayed on display 680. In some cases, it is contemplated that embodiments can be implemented using a single instance of computing device 600, while in other embodiments multiple such systems, or multiple nodes making up the computing device 600, can be configured to host different portions or instances of various embodiments. For example, in one embodiment some elements can be implemented via one or more nodes of the computing device 600 that are distinct from those nodes implementing other elements. In another example, multiple nodes may implement the computing device 600 in a distributed manner.

In different embodiments, the computing device 600 can be any of various types of devices, including, but not limited to, a personal computer system, desktop computer, laptop, notebook, tablet or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, the computing device 600 can be a uniprocessor system including one processor 610, or a multiprocessor system including several processors 610 (e.g., two, four, eight, or another suitable number). Processors 610 can be any suitable processor capable of executing instructions. For example, in various embodiments processors 610 may be general-purpose or embedded processors implementing any of a variety of instruction set architectures (ISAs). In multiprocessor systems, each of processors 610 may commonly, but not necessarily, implement the same ISA.

System memory 620 can be configured to store program instructions 622 and/or data 632 accessible by processor 610. In various embodiments, system memory 620 can be implemented using any suitable memory technology, such as static random-access memory (SRAM), synchronous dynamic RAM (SDRAM), nonvolatile/Flash-type memory, or any other type of memory. In the illustrated embodiment, program instructions and data implementing any of the elements of the embodiments described above can be stored within system memory 620. In other embodiments, program instructions and/or data can be received, sent or stored upon different types of computer-accessible media or on similar media separate from system memory 620 or computing device 600.

In one embodiment, I/O interface 630 can be configured to coordinate I/O traffic between processor 610, system memory 620, and any peripheral devices in the device, including network interface 640 or other peripheral interfaces, such as input/output devices 650. In some embodiments, I/O interface 630 can perform any necessary protocol, timing or other data transformations to convert data signals from one component (e.g., system memory 620) into a format suitable for use by another component (e.g., processor 610). In some embodiments, I/O interface 630 can include support for devices attached through various types of peripheral buses, such as a variant of the Peripheral Component Interconnect (PCI) bus standard or the Universal Serial Bus (USB) standard, for example. In some embodiments, the function of I/O interface 630 can be split into two or more separate components, such as a north bridge and a south bridge, for example. Also, in some embodiments some or all of the functionality of I/O interface 630, such as an interface to system memory 620, can be incorporated directly into processor 610.

Network interface 640 can be configured to allow data to be exchanged between the computing device 600 and other devices attached to a network (e.g., network 690), such as one or more external systems or between nodes of the computing device 600. In various embodiments, network 690 can include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 640 can support communication via wired or wireless general data networks, such as any suitable type of Ethernet network, for example; via digital fiber communications networks; via storage area networks such as Fiber Channel SANs, or via any other suitable type of network and/or protocol.

Input/output devices 650 can, in some embodiments, include one or more display terminals, keyboards, keypads, touchpads, scanning devices, voice or optical recognition devices, or any other devices suitable for entering or accessing data by one or more computer systems. Multiple input/output devices 650 can be present in computer system or can be distributed on various nodes of the computing device 600. In some embodiments, similar input/output devices can be separate from the computing device 600 and can interact with one or more nodes of the computing device 600 through a wired or wireless connection, such as over network interface 640.

Those skilled in the art will appreciate that the computing device 600 is merely illustrative and is not intended to limit the scope of embodiments. In particular, the computer system and devices can include any combination of hardware or software that can perform the indicated functions of various embodiments, including computers, network devices, Internet appliances, PDAs, wireless phones, pagers, and the like. The computing device 600 can also be connected to other devices that are not illustrated, or instead can operate as a stand-alone system. In addition, the functionality provided by the illustrated components can in some embodiments be combined in fewer components or distributed in additional components. Similarly, in some embodiments, the functionality of some of the illustrated components may not be provided and/or other additional functionality can be available.

The computing device 600 can communicate with other computing devices based on various computer communication protocols such a Wi-Fi, Bluetooth® (and/or other standards for exchanging data over short distances includes protocols using short-wavelength radio transmissions), USB, Ethernet, cellular, an ultrasonic local area communication protocol, etc. The computing device 600 can further include a web browser.

Although the computing device 600 is depicted as a general purpose computer, the computing device 600 is programmed to perform various specialized control functions and is configured to act as a specialized, specific computer in accordance with the present principles, and embodiments can be implemented in hardware, for example, as an application specified integrated circuit (ASIC). As such, the process steps described herein are intended to be broadly interpreted as being equivalently performed by software, hardware, or a combination thereof.

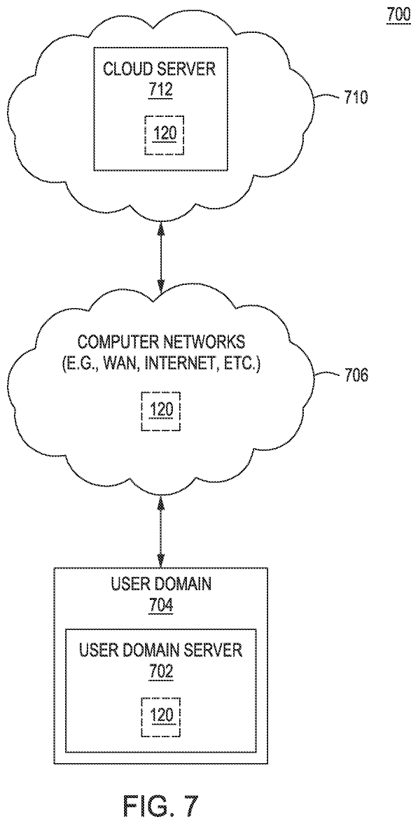

FIG. 7 depicts a high-level block diagram of a network in which embodiments of a sensitive dataflow tracking system in accordance with the present principles, such as the sensitive dataflow tracking system 120 if FIGS. 1 and 2B, can be applied. The network environment 700 of FIG. 7 illustratively comprises a user domain 702 including a user domain server/computing device 704. The network environment 700 of FIG. 7 further comprises computer networks 706, and a cloud environment 710 including a cloud server/computing device 712.

In the network environment 700 of FIG. 7, a system for sensitive dataflow tracking in accordance with the present principles, such as the system 120 of FIGS. 1 and 2B, can be included in at least one of the user domain server/computing device 704, the computer networks 706, and the cloud server/computing device 712. That is, in some embodiments, a user can use a local server/computing device (e.g., the user domain server/computing device 704) to provide sensitive dataflow tracking in accordance with the present principles.

In some embodiments, a user can implement a system for sensitive dataflow tracking in the computer networks 706 to provide sensitive dataflow tracking in accordance with the present principles. Alternatively or in addition, in some embodiments, a user can implement a system for sensitive dataflow tracking in the cloud server/computing device 712 of the cloud environment 710 to provide sensitive dataflow tracking in accordance with the present principles. For example, in some embodiments it can be advantageous to perform processing functions of the present principles in the cloud environment 710 to take advantage of the processing capabilities and storage capabilities of the cloud environment 710.

In some embodiments in accordance with the present principles, a system for providing sensitive dataflow tracking in a container network can be located in a single and/or multiple locations/servers/computers to perform all or portions of the herein described functionalities of a system in accordance with the present principles. For example, in some embodiments, containers 110 of a container network can be located in one or more than one of the a user domain 702, the computer network environment 706, and the cloud environment 710 and at least one global manager of the present principles, such as the global manager 120, can be located in at least one of the user domain 702, the computer network environment 706, and the cloud environment 710 for providing the functions described above either locally or remotely.

In some embodiments, sensitive dataflow tracking of the present principles can be provided as a service, for example via software. In such embodiments, the software of the present principles can reside in at least one of the user domain server/computing device 704, the computer networks 706, and the cloud server/computing device 712. Even further, in some embodiments software for providing the embodiments of the present principles can be provided via a non-transitory computer readable medium that can be executed by a computing device at any of the computing devices at the user domain server/computing device 704, the computer networks 706, and the cloud server/computing device 712.

Those skilled in the art will also appreciate that, while various items are illustrated as being stored in memory or on storage while being used, these items or portions of them can be transferred between memory and other storage devices for purposes of memory management and data integrity. Alternatively, in other embodiments some or all of the software components can execute in memory on another device and communicate with the illustrated computer system via inter-computer communication. Some or all of the system components or data structures can also be stored (e.g., as instructions or structured data) on a computer-accessible medium or a portable article to be read by an appropriate drive, various examples of which are described above. In some embodiments, instructions stored on a computer-accessible medium separate from the computing device 600 can be transmitted to the computing device 600 via transmission media or signals such as electrical, electromagnetic, or digital signals, conveyed via a communication medium such as a network and/or a wireless link. Various embodiments can further include receiving, sending or storing instructions and/or data implemented in accordance with the foregoing description upon a computer-accessible medium or via a communication medium. In general, a computer-accessible medium can include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods and processes described herein may be implemented in software, hardware, or a combination thereof, in different embodiments. In addition, the order of methods can be changed, and various elements can be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. When provided as software, embodiments of the present principles can reside in at least one of a computing device, such as in a local user environment, a computing device in an Internet environment and a computing device in a cloud environment. Embodiments can also be implemented as instructions stored using one or more machine-readable media, which may be read and executed by one or more processors. A machine-readable medium can include any mechanism for storing or transmitting information in a form readable by a machine (e.g., a computing device or a “virtual machine” running on one or more computing devices). For example, a machine-readable medium can include any suitable form of volatile or non-volatile memory.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

This disclosure is to be considered as exemplary and not restrictive in character, and all changes and modifications that come within the guidelines of the disclosure are desired to be protected.

1. A taint tracking system for providing sensitive dataflow tracking for containerized applications, comprising:
an audit reporter configured to receive audit records including container information and to create a provenance graph of vertices and edges associated with kernel system call events being monitored based on the received audit records;
a taint tracking kernel configured to (1) create a screened provenance graph that includes data deemed sensitive by performing a first level of pruning of the provenance graph using one or more storage screens, and (2) create one or more final taints set of sensitive data to be tracked at a container level that includes vertices and edges that are descended from a particular sensitive source using one or more dependency checkers; and
a taint storage configured to store the taint sets of sensitive data to be tracked at the container level.

2. The taint tracking system of claim 1, further comprising:
a bridge translator configured to generate one or more synthesized audit records that includes container information associated with each event based on one or more received event audit records.

3. The taint tracking system of claim 1, wherein the taint tracking system includes a single audit reporter, a single taint tracking kernel, and a single taint storage.

4. The taint tracking system of claim 1, further comprising a sensitivity manifest and a sensitivity manifest ingester which processes the sensitivity manifest to produce the storage screen used by the taint tracking kernel to screen the vertices and edges that get stored in the provenance graph.

5. The taint tracking system of claim 4, wherein the sensitivity manifest includes annotated provenance graph vertices and/or edges that are identified as being sensitive.

6. The taint tracking system of claim 4, wherein the sensitivity manifest includes particular files, particular processes, and/or particular network flows that are identified as sensitive and are tracked.

7. The taint tracking system of claim 4, wherein the storage screen created based on the sensitivity manifest describes to the taint tracking system where sensitive data is located within a container, which application produces new sensitive data, and from where/which? remote network services data can be imported.

8. The taint tracking system of claim 1, wherein the one or more dependency checkers are configured to check ancestral lineage of the vertices and edges included in the screened provenance graph and keep track of a sub-graph that is descended from every sensitive vertex included in the screened provenance graph.

9. The taint tracking system of claim 8, further comprising a flagged destination configuration file which includes a list of vertices that should be considered destinations that should be flagged as tainted, and wherein at least one of the one or more dependency checkers is configured to:
determine, for each edge in the screened provenance graph, whether a child of an edge being processed is a flagged destination within the flagged destination configuration file;
determine whether a parent is in any of the taint sets stored in the taint storage if the child is a flagged destination; and
log an entry in a log file that indicates that there was a sensitive source that was associated with the flagged destination if the parent is in any of the taint sets.

10. The taint tracking system of claim 1, further comprising:
one or more network-tagged provenance coordination (NTPC) systems; and
a network tagged specification file that includes a list of all the vertices that are deemed sensitive and therefore should be tracked,
wherein the one or more NTPC systems are configured to include labels to any network packets that meets criteria defined in a network tagged specification file.

11. A method for providing sensitive dataflow taint tracking for containerized applications, comprising:
generating one or more synthesized audit records based on received event audit records that includes container information associated with each event included in the synthesized audit records;
creating a provenance graph of vertices and edges associated with kernel system call events being monitored based on the one or more synthesized audit records;
creating a screened provenance graph that includes data deemed sensitive by performing a first level of pruning of the provenance graph using one or more storage screens;
creating one or more final taints set of sensitive data to be tracked at a container level, that includes vertices and edges that are descended from a particular sensitive source using one or more dependency checkers; and
storing the taint sets of sensitive data to be tracked at the container level within a taint storage.

12. The method of claim 11, wherein the storage screen is by a sensitivity manifest ingester based on a sensitivity manifest that is input into the sensitivity manifest ingester to produce the storage screen used to screen the vertices and edges that get stored in the provenance graph.

13. The method of claim 12, wherein the sensitivity manifest includes annotated provenance graph vertices and/or edges that should be considered sensitive.

14. The method of claim 11, wherein creating one or more final taints set of sensitive data to be tracked at a container level using the dependency checker comprises:
checking ancestral lineage of the vertices and edges included in the screened provenance graph;
and tracking a sub-graph that is descended from every sensitive vertex included in the screened provenance graph.

15. The method of claim 11, further comprising:
receiving a flagged destination configuration file which includes a list of vertices should be considered destinations that should be flagged as sensitive; and
determining, for each edge in the screened provenance graph, whether a child of an edge being processed is a flagged destination within the flagged destination configuration file;
determining whether the parent is in any of the taint sets stored in the taint storage if the child is a flagged destination; and
logging an entry in a log file that indicates that there was a sensitive source that was associated with the flagged destination if the parent is in any of the taint sets.

16. One or more non-transitory computer readable media having instructions stored thereon which, when executed by one or more processors, cause the one or more processors to perform operations comprising:
generating one or more synthesized audit records based on received event audit records that includes container information associated with each event included in the synthesized audit records;
creating a provenance graph of vertices and edges associated with kernel system call events being monitored based on the one or more synthesized audit records;
creating a screened provenance graph that includes data deemed sensitive by performing a first level of pruning of the provenance graph using one or more storage screens;
creating one or more final taints set of sensitive data to be tracked at a container level, that includes vertices and edges that are descended from a particular sensitive source using one or more dependency checkers; and
storing the taint sets of sensitive data to be tracked at the container level within a taint storage.

17. A method for providing network-tagged provenance coordination for containerized applications, comprising:
receiving a network tagged specification file that includes a list of all vertices that are deemed sensitive and therefore should be tracked;
initiating one or more network-tagged provenance coordination (NTPC) systems;
checking, by the one or more NTPC systems, all outgoing network packets to determine whether any network packets meets criteria defined in a network tagged specification file; and
including, by the one or more NTPC systems, a label to a header of any network packets that meets the criteria defined in a network tagged specification file.

18. A method of providing sensitive dataflow policy violations, comprising:
deploying one or more networked taint tracking systems on a network;
detecting, by the networked taint tracking systems, sensitive data requiring taint tracking based on analysis of received event audit records;
generating, by the one or more networked taint tracking systems, taints sets that include sensitive data being monitored and result in the tracking of sensitive dataflow policy violation alerts; and
storing the taint sets of sensitive data being monitored at the container level within a taint storage.

19. The method of claim 18, wherein generating the taints sets that include sensitive data being monitored includes using a storage screen based on a sensitivity manifest as input to screen the vertices and edges that get stored in a provenance graph and result in the tracking of sensitive dataflow policy violation alerts.

20. The method of claim 18, wherein generating the taints sets that include sensitive data being monitored includes using a dependency checker and a set of flagged destinations as input to the dependency checker to screen the vertices and edges that get stored in a provenance graph and result in the tracking of sensitive dataflow policy violation alerts.
